(19) United States
(12) Patent Application Publication
(10) Pub. No.: US 2008/0092031 A1
(43) Pub. Date: Apr. 17, 2008

(54) Rich media printer

(76) Inventors: Steven John Simske, Fort Collins, CO (US); Sean Beary, Louisville, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/044,860

(22) Filed: Jan. 26, 2005

Related U.S. Application Data
(60) Provisional application No. 60/592,647, filed on Jul. 30, 2004.

(51) Int. Cl. G06F 17/00

(52) U.S. Cl. 715/201

(57) ABSTRACT

A method of creating a print document including rich media content. The method includes receiving a document to be printed, receiving rich media content to be associated with the document to be printed, converting the rich media content to one or more discrete frames to be incorporated in the document to be printed, and inserting the one or more discrete frames into the document to be printed.

### RELATED APPLICATIONS

This application claims priority of U.S. Provisional Application Ser. No. 60/592,647 of Steven J. Simske et al. filed 30 Jul. 2004 and titled RICH MEDIA PRINTER.

### BACKGROUND

Copiers, multifunctional printers (MFP's), commercial and network scanners (or digital senders), and other capture devices may be used to create multi-page printed documents. The printed documents may be configured to contain both text and images. For example, a printed document may include an image in a top section of a printed page with related text appearing below the image.

However, printers are generally not configured to print rich media content, such as video content, either exclusively or in combination with text documents. Printing rich media content may allow a user to incorporate the rich media content in printed documents for both decorative and functional uses.

### BRIEF DESCRIPTION OF THE DRAWINGS

FIG. 1 is a schematic illustration of printing system 10, according to an exemplary embodiment.

FIG. 2 is a flowchart illustrating a method for creating and printing a document including rich media content, according to an exemplary embodiment.

FIG. 3 is a rich media content series including a series of discrete frames, according to an exemplary embodiment.

FIG. 4 is a rich media content series including a first type of error frame, according to an exemplary embodiment.

FIG. 5 is a rich media content series including a second type of error frame, according to an exemplary embodiment.

### DETAILED DESCRIPTION OF EXAMPLE EMBODIMENT

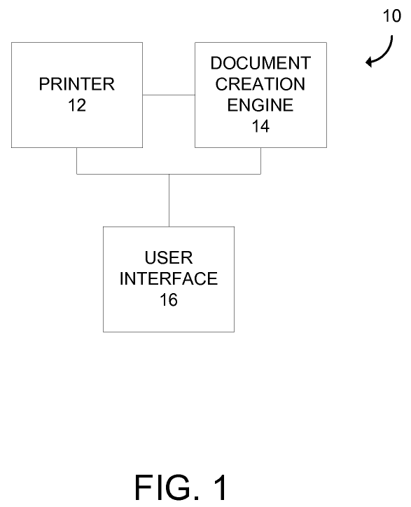

FIG. 1 is a schematic illustration of a printing system 10. Printing system 10 is generally configured to print a document that has been merged with rich media content. Rich media content may include video clips in any of a variety of formats.

Printing system 10 includes a printer 12, a document creation engine 14, and a user interface 16. System 10 may further include additional components such as a memory, a network communication device, an associated computing device, a scanner, other input devices, or any other device or system configured to facilitate printing of one or more documents containing rich media content.

Printer 12 may be any type of printer configured to receive data from document creation engine 14 and create a print document based on the received data. For example, printer 12 may be a copier, multifunctional printer, commercial and network scanner, or other capture device configured to create a printed document. A printed document may include any hardcopy version of the print document on paper, a merged output format such as PDF or XML, or any other print document. According to an exemplary embodiment, document creation engine 14 may be a component of printer 12.

Document creation engine 14 generally comprises a processor unit configured to generate control signals which are transmitted to printer 12. Document creation engine 14 may comprise a processing unit that executes sequences of instructions contained in a memory (not shown). Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Document creation engine 14 is not limited to any specific combination of hardware circuitry and software, nor to any particular source for the instructions executed by the processing unit.

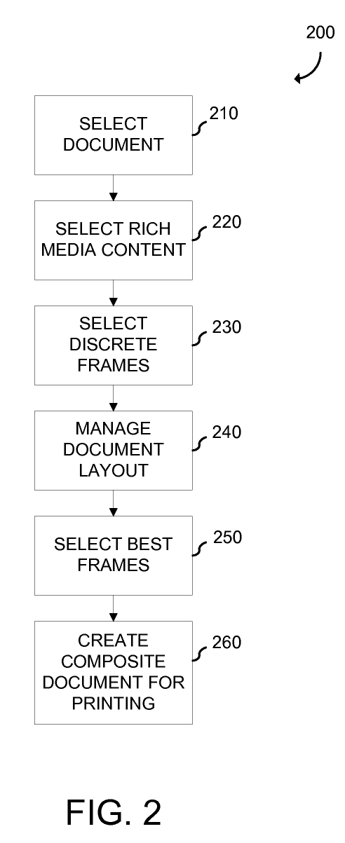

User interface 16 may be any type of user interface configured to facilitate creation of a printed document that includes rich media content. According to an exemplary embodiment, user interface 16 may be a user interface associated with printer 12. User interface 16 may include an LCD screen configured to guide a user through a process of incorporating rich media content in a printed document, further described below with reference to FIG. 2. User interface 16 may further include a plurality of input devices such as a touch screen, a plurality of input keys, a joystick, etc. configured to receive user input.

User interface 16 may also be a user interface implemented on a personal computing system associated with print system 10. For example, user interface 16 may be a graphical user interface configured to perform the process of associating rich media content with a printed document. The graphical user interface may include, for example, a formatting area allowing the user to customize the appearance of the printed document, an input area allowing the user to customize the content of the printed document, a plurality of input keys configured to receive input data from the user, etc.

Document creation engine 14 is configured to receive data representing rich media to be printed or incorporated in a printed document from any of a variety of suitable sources, including a media reader, a computer, a scanner, or directly from memory of a device, such as a video camera, digital camera, and the like. Document creation engine 14 is further configured to convert the rich media content into a format that suitable for printing or incorporation in a print document, as will be further discussed below with reference to FIG. 2. Document creation engine 14 may be further configured to implement one or more functions to customize the content or appearance of the rich media content as it is incorporated in the printed document.

Advantageously, document creation engine 14 in combination with printer 12 allows a user to customize a printed document by incorporating rich media content into the printed document. One way to combine video documents/print copy is a decorative one; when copying/custom publishing a book, the addition of sequential video frames to for example the upper right corner of the pages creates a “video-in-book” when the book reader “flips” through the pages. This is a familiar feature, for example in kids' comics, cartoon or otherwise fun-related paperback books. With it, the video and document content may be completely independent; that is, they need not related all. “Video-in-book” style printing uses only a few frames from the video to enhance the printed document and printed document itself is the “primary” content.

Video frames may also be the primary content of the printed document. The frames may be accompanied by minor identify content such as page numbers, etc. The video frames can be printed directly on proof sheets, e.g. 30 seconds worth of frames, typically 30 frames, at a time, to ensure consistency of quality and absence of frames of deviant merit or value. The proof sheets may be used, for example, to facilitate editing of film or in reviewing industrial processes.

Referring now to FIG. 2, a method 200 for incorporating rich media content in a printed document is shown, according to an exemplary embodiment. Document creation engine 14 may be configured to implement method 200 alone or in combination with one or more additional systems or devices.

In a step 210, a user may utilize document creation engine 14 and/or user interface 16 to select the document to be printed. Selecting the document to be printed may include receiving the document in an automatic document feeder of a copier or multifunctional printer, “printing” from an application, right clicking on the file from a personal computing device such as any personal computer, laptop, PDA, etc., or by reloading a stored version of the document on a copier or multifunctional printer to be used to create the printed document.

In a step 220, a user may utilize document creation engine 14 and/or user interface 16 to select one or more video clips or other rich media content to be associated with the document. Selection may be performed using an LCD, button pad, and other function and/or device associated with user interface 16 on the printing system 10 or an application actuating printing system 10 remotely.

According to an exemplary embodiment, printing system 10 may be configured to store a plurality of video clips in memory that may be appropriate to common topics. Advantageously, stored rich media content may be used in a similar fashion as “clip art” still images to augment the appearance of printed documents. Print system 10 may be configured such that the rich media content may be received and processed in any of a plurality of file types, such as wave media files (.wmv), QuickTime files (.mov), MPEG movie files (.mpeg), AVI movie files (.avi), etc.

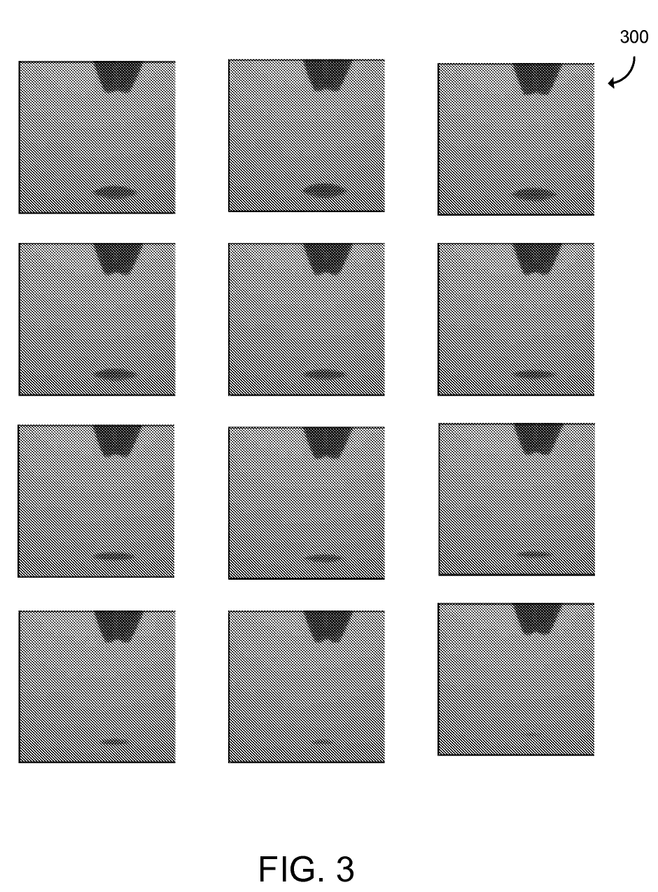

Selection of the rich media content to be included in the printed document may further include the conversion of the rich media content into a format that is suitable for insertion into the printed document. For example, a video stream may be converted into a plurality of discrete frames or still images in a rich media content series that are representative of the video stream using an MPEG extraction application. Referring now to FIG. 3, a rich media content series 300 including rich media content that has been converted for use in a printed document is shown according to an exemplary embodiment. A rich media content series may be formed from any type of video clip as described above. Rich media content series 300 was taken from a video clip related to spotting fluid delivery. (Broz J J, Simske S J “Characterizing microarray spotting fluid delivery using novel image analysis methods and industrial designed experiments.”, SmallTalk2003 Microfluidics, Microarrays and BioMEMS Conf., 2003).

Although the rich media content series illustrated was generated from stored rich media video clips, the rich media content may be received from any other location, including flash memory, any video-capturing device, such as a digital camera, digital video recorder, etc., or a storage hardware device. The source of the rich media content may be connected to printing system 10 either directly or indirectly, for example, communicating via 802.11, USB, Bluetooth, wireless, fire wire, or other interface protocol. Further, a specific application or plurality of videos may be linked to the printing system 10 via http or any other communication protocol to allow the user a select the rich media content from a plurality of locations.

Following receipt of the rich media content, document creation engine 14 may be configured to facilitate conversion of the rich media content into the series of discrete frames or rich media content series. The rich media content may be converted using any of a variety of applications to convert video input to a series of discrete frames. The conversion application may be an application implemented within document creation engine 14 or an external application called by document creation engine 14.

For example, the conversion application may be configured to perform a series of operations to convert the rich media content based on inputs from the user. The conversion application may be configured such that the conversion process is customizable to a greater or lesser degree by the user.

According to an exemplary conversion process, the video frames may be individually stored in a directory as JPEG files as shown in rich media content series 300. The original .wmv format video used to generate rich media content series 300 was 5 minutes in length, with 30 frames/sec. The inputs used to customize the conversion process may be provided by the user using any of a variety of methods such as inputs in a .XML file, inputs entered using a user interface for the conversion application, etc. An exemplary .XML file may be:

<FrameExtractionSettings>
<Video File>\\Telechem\TelechemSubstrate.wmv</Video File>
<nFrames>9000</nFrames>
<nFramesSelected>12</nFramesSelected>
<SelectionType>MaximalRangeCoverage</SelectionType>
</FrameExtractionSettings>

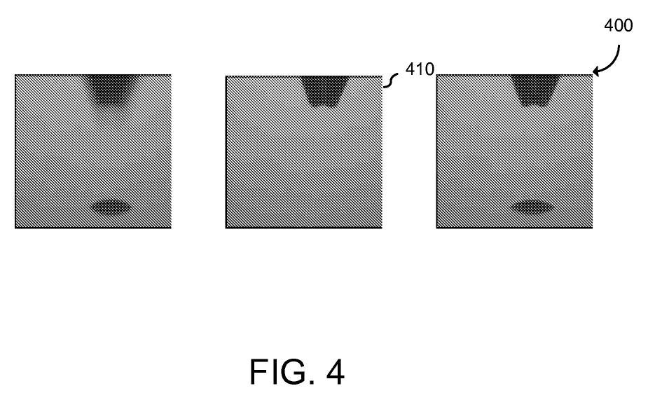

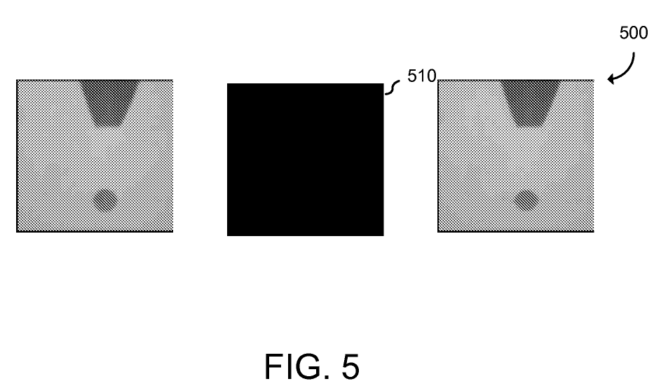

In some cases, the conversion application or the video clip may have some inherent defects such that not all of the extracted discrete frames may be high quality, error-free discrete frames. Accordingly, the conversion application and/or document creation engine 14 may be configured to recognize a account for defective frames, as will be further discussed below with reference to FIGS. 4 and 5.

In the XML file sample above, the <nFramesSelected> and <SelectionType> elements dictate the selection of the frames. For maximal range coverage, the N frames are placed (nFrames/N) apart, so that the first frame is the (N/2) frame and the last frame is the (nFrames−(N/2)) frame. For this particular video, then, frames 375, (375+750), (375+2*750), . . . , (375+11*750)—that is, frames 375, 1125, 1875, . . . , 8625—were chosen for the gallery. Many other selection possibilities exist, and these are instantiated primarily by different settings for <SelectionType>, although <nFramesSelected> can also be dynamically selected in the case of fitting all of the video frames into a template.

For <nFramesSelected>, the number of frames value can be set using any of a number of criteria based on the preferences of the user. For example, the number of frames value may be set to equal half the number of pages in a document. This number of frames may be used where one frame goes into the upper right corner of each odd page, for the “video-in-book” hand-flipping option. The number of frames value may also be set to equal the number of pages in a document. This number of frames may be used where a video frame motif is echoed on each page. Further, the number of frames may equal a slightly reduced number from the methods above if the user does not want, for example, the title page, table of contents, bibliography, etc., to have the video motif. Yet further, the number of frames value may be set based on a template not specifically related to the document, e.g., a page template may include spaces for, say, 12 video frames as shown in FIG. 1 for editing purposes.

Referring again to FIG. 2, in a step 230, printing system 10 is configured to allow the user to select the frames from the rich media content series to be incorporated in the printed document. The frames may be selected using any of a plurality of selection types of varying sophistication. For example, the selection type may include user selected frames where the user searches through the overall gallery of discrete frames and picks the frames to be incorporated.

Alternatively, the selection type may include an automated process configured to select frames based on a selection criteria. For example, selection type may include maximal range coverage, wherein the frames are selected based on the number of total frames.

Selection type may alternatively include maximal scene coverage, wherein video segmentation techniques are performed as follows: the video frames are decompiled (extracted), and sequential frames are compared for their “frame signatures”. Signatures are descriptions of the frames based on their region content, their background color/texture, their edge maps and other identifying salient features. In a “normal” video experience, the differences between consecutive frames will tend to fit a “bimodal” curve, where either the changes (ΔSignature) are relatively small (that is, ΔSignature<Tₐ) or are very large (that is, ΔSignature>T_{sc}) where “Tₐ” represents associated frames (in a single “shot” or scene) and “T_{sc}” represents a “scene change. Typically, Tₐ<<T_{sc} and there is no overlap between these two populations.

ΔSignature generation may be calculated based on a combination of factors. First, a threshold pixel correlation (Cₜₚ) may be calculated. A threshold pixel correlation value is the exact correlation between the threshold (binarized) pixels in two frames. Second, the correlation between x- and y-direction projection profiles may be calculated. Projection profiles are the counts of black binarized pixels for each row (x-) and column (y-) of the binarized frames. The “percent black” of each row/column is correlated between two frames, and these two directional values may be designated C_{PPx} and C_{PPy}. Third, a frame histogram correlation is generated. The frame histogram is the distribution of the gray or color values of each frame, and not the binarized values. The distribution elements are the individual elements in the correlation, designated C_{H}. A weighting of these three factors is the ΔSignature value: ΔSignature=C_{N}/[(Wₜₚ*Cₜₚ)+(W_{PPx}*C_{PPx})+(W_{PPy}*C_{PPy})+(W_{H}*C_{H})] where generally W_{PPx}=W_{PPy}, and C_{N} is defined so that the peak value for ΔSignature is a desired value—e.g. 1.0.

Unfortunately, rich media content containing error frames may have artificially high ΔSignature that do not represent true scene changes. Referring now to FIG. 4, a rich media content series 400 including an error frame 410 is shown, according to an exemplary embodiment. Document creation engine 14 and/or the conversion application may include one or more error handling functions. Error frames may introduce problems by creating artificially high ΔSignature. The artificially high ΔSignature may be created in two consecutive frames where a blank frame or black frame has a high ΔSignature compared to the frame before it and after it. Error frames may be addressed by noting that the ΔSignature for the frames one before and one after the error frame is low. Thus, two consecutive high ΔSignature's implies the possibility of an error frame E, while a low ΔSignature for the E−1 compared to E+1 frame verifies this . . . the blank/black frame is simply replaced by either the E−1, E+1 or “morphed” combination of the two frames. Then, the frame-to-frame populations are more bimodal as described above.

Referring now to FIG. 5, a rich media content series 500 including a second type of error frame 510 is shown, according to an exemplary embodiment. The second type of error frame may occur if part of a frame is dropped. In this case, the value of ΔSignature may be an intermediate value; that is, Tₐ<ΔSignature<T_{sc}. Because of the intermediate value, such frames can distort the computation of Tₐ and T_{sc}. If the second type of error are not removed, the error frames are included in the set of frames used to calculate the distribution for ΔSignature. Accordingly, document creation engine 14 may be configured to account for the second type of error frame as well.

Accounting for the second type of error frame may include computing the ΔSignature for a series of frames to find candidate “missing region” frames. Such a sequence may look like the following (normalized so 1.0 is the maximum): {0.01, 0.01, 0.06, 0.01, 0.01, 0.01, 0.02, 0.01, 0.03, 0.02, 0.01, 0.15, 0.01, . . . }. Next, determine candidate “missed region” frames. For example, using the series provided above, the third in the sequence, 0.06, is a candidate as it is well above what we expect to be the “<Tₐ” ΔSignature values of 0.01-0.03, but well below the higher values (e.g., 0.15-1.00) which represents the “<T_{sc}” ΔSignature values. The expected range may easily be ascertained using a variety of peak-finding algorithms.

A particularly high value, such as 0.15 in the series above, may be an actual scene transition frame. The status of the particularly high value may be verified by computing the “E−1/E+1 ΔSignature” around the particularly high value. For the example above, for { . . . , 0.01, 0.06, 0.01, . . . }, the “E−1/E+1 ΔSignature”, i.e., the signature difference between the two frames at 0.01, equals 0.02. However, for { . . . , 0.01, 0.15, 0.01, . . . } the “E−1/E+1 ΔSignature” equals 0.13. The 0.06 value frame may be classified as a “region missing frame” while the 0.15 value frame is likely a true “scene transition” frame since the signature difference is still higher.

Additionally, document creation engine 14 may be configured to verify any missing region frames are missing regions compared to frames around them through a zoning (region) analysis. A zoning analysis may include using a region analysis engine to compute the regions in an image. An exemplary region analysis engine is described in (Wahl, F. M., Wong, K. Y. and Casey, R. G., 1982. “Block segmentation and text extraction in mixed/image documents,” Computer Vision Graphics and Image Processing, Vol. 2, pp. 375-390.”). When a region present in the E−1 and E+1 frames is verified absent in the “E” frame, as above, the E-frame may be simply replaced by either the E−1, E+1, or “morphed” combination of the two frames. Then, the frame-to-frame populations are more bimodal, as described above. Any erroneous frames may be replaced prior to selection when an error is discovered to ensure that a valid frame is present in the sequence in case the error frame is chosen.

Referring again to FIG. 2, in a step 240, printing system 10 may be configured to allow the user to manage the frame layout. Managing frame layout may include the fitting of frames into any template or layout. Exemplary frame layouts may include: (1) “video-in-book” may be configured to use the upper right corner of even pages (right-hand pages when the book lays open), (2) motifed pages may use a prescribed template (this is called a “fixed region” it occurs in a fixed place from one page to the next, but has dynamic content) so the user sees the video frames in a consistent location from page-to-page (e.g. the “highlight” in the upper left on many overhead projector/PowerPoint slides), and (3) scene verification, wherein a representative frame from a verified scene, i.e., sequential frames with low ΔSignature values, occupies a single position in the template. A scene verification layout may be configured to include frame information, e.g. timing information, associated with each frame as shown in the printed document.

In a step 250, printing system 10 may be configured to allow the user to select the best frame/s and/or context-specific frames. For example, for scenes, the middle frame of the scene sequence can be chosen. Selection may also include automatically determining a “characteristic” or “best” frame exists, such using digital signatures to identify a specific scene or frame content, using any number of techniques, including, but not limited to, finding the frame with a maximum value for ΔSignature referenced to the other frames in the scene as further discussed below with reference to determining frames to include.

For context specific frames, any variety of means can be used to select the frames, including shape/logo matching, face recognition matching, etc. For example, if the scenes are greatly different in length, it may be that two or more frames better represent longer scenes. In this case, the two most different frames in a scene may be chosen by, for example, performing frame-frame signature calculations, thus generating a 2-D array of ΔSignature values, rather than the 1-D set described above.

In a step 260, printing system 10 may be configured to create the composite document as a single file version of the created document for use in various print jobs and/or applications. In the created document, the frames associated with the document are rendered as part of the document, and archived/printed/saved as a particular file format (PDF, XML, etc.), or otherwise used for the user's purposes.

Although flowchart 200 includes specific steps in a specific order, alternative embodiments may include more, less, and/or different steps to achieve the functions described herein. Further, ordering of the steps may modified as desirable.

Printing system 10 may further be configured to create a video clip from a series of discrete frames that are loaded into memory. Advantageously, the video creation function enables users to perform translation of sets of one or more frames into video. The frames may be loaded into printing system 10 using any of a variety of methods such as scanning, file transfer, etc.

Printing system 10 may be configured to implement a method for determining frames to represent each scene for inclusion in the video. First, the discrete frames may be grouped into scenes. Second, the frames that best represent/s each individual scene is/are selected for hardcopy. Third, after the integrity of the video is verified on a frame-by-frame basis, and subsequent irregularities, i.e. blank frames, black frames, missing regions, etc, as described above, are replaced, e.g. with “morphing” or surrounding frame interpolation, the frames with the greatest net-ΔSignature values are selected to represent the scene. The net-ΔSignature values are ΔSignature values computed with variable steps between frames, then normalized to the number of comparisons—this value indicates frames which most “stand out” in a set. Video for the frames can be obtained by capturing specific frames and then interpolating/morphing between frames to fill in the missing frames upon recovery of the video. Depending on the “morphing” technique used, it may be advantageous to include the first and last frames to prevent the need for extrapolation. Additionally, it is possible to replace the original video with static frames that have staggered still frames. The reconstituted video may be configured to be the same length as the original.

Although the present invention has been described with reference to example embodiments, workers skilled in the art will recognize that changes may be made in form and detail without departing from the spirit and scope of the invention. For example, although different example embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method of creating a print document including rich media content,: comprising:
receiving a document to be printed;
receiving rich media content to be associated with the document to be printed;
converting the rich media content to one or more discrete frames to be incorporated in the document to be printed; and
inserting the one or more discrete frames into the document to be printed.

2. The method of claim 1, wherein converting the rich media content to one or more discrete frames includes actuating an external application to generate the one or more discrete frames from the rich media content.

3. The method of claim 1, wherein inserting the one or more discrete frames into the document includes receiving a selection criteria to allow selection of one or more discrete frames.

4. The method of claim 3, wherein the selection criteria includes a digital signature level.

5. The method of claim 4, wherein converting the rich media content to one or more discrete frames to be incorporated in the document to be printed includes generating a digital signature for each of the one or more discrete frames.

6. The method of claim 4, wherein selecting one or more discrete frames according to a selection criteria includes determining whether a discrete frame has a digital signature indicating a substantial deviation from associated discrete frames.

7. The method of claim 6, further including identifying potentially erroneous or deviant content in the rich media content based on the substantial deviation from associated discrete frames.

8. The method of claim 1, further including receiving input from a user to select from the one or more discrete frames for insertion in the printed document.

9. The method of claim 1, further including receiving input from a user to configure how a discrete frame is inserted into the printed document.

10. The method of claim 9, wherein receiving input from a user to configure how a discrete frame is inserted into the printed document includes receiving input from the user to position the discrete frame in the printed document.

11. The method of claim 9, wherein receiving input from a user to configure how a discrete frame is inserted into the printed document includes receiving input from the user to configure the appearance of the discrete frame in the printed document.

12. A print system, comprising
a document creation engine configured to generate a document to be printed incorporating rich media content; and
a printer configured to print document to be printed.

13. The print system of claim 12, wherein generating a document to be printed includes the steps of:
receiving a document to be printed;
receiving rich media content to be associated with the document to be printed;
converting the rich media content to one or more discrete frames to be incorporated in the document to be printed; and
inserting the one or more discrete frames into the document to be printed.

14. The print system of claim 13, wherein converting the rich media content to one or more discrete frames includes actuating an external application to generate the one or more discrete frames from the rich media content.

15. The print system of claim 13, wherein inserting the one or more discrete frames into the document includes selecting one or more discrete frames according to a selection criteria.

16. The print system of claim 15, wherein the selection criteria includes a digital signature algorithm.

17. The print system of claim 16, wherein converting the rich media content to one or more discrete frames to be incorporated in the document to be printed includes generating a digital signature for each of the one or more discrete frames.

18. The print system of claim 16, wherein selecting one or more discrete frames according to a selection criteria includes determining whether a discrete frame has a digital signature indicating a substantial deviation from associated discrete frames.

19. The print system of claim 18, further including identifying erroneous or deviant content in the rich media content based on the substantial deviation from associated discrete frames.

20. The print system of claim 13, wherein generating a document to be printed further includes receiving input from a user to select from a plurality of discrete frames for insertion in the printed document.

21. The print system of claim 13, wherein generating a document to be printed further includes receiving input from a user to configure how a discrete frame is inserted into the printed document.

22. The print system of claim 21, wherein receiving input from a user to configure how a discrete frame is inserted into the printed document includes receiving input from the user to position the discrete frame in the printed document.

23. The print system of claim 21, wherein receiving input from a user to configure how a discrete frame is inserted into the printed document includes receiving input from the user to configure the appearance of the discrete frame in the printed document.

24. A printer, comprising:
memory configured to receive a document to be printed and rich media content to be inserted in the document to be printed; and
a user interface configured to allow a user to customize how the rich media content is inserted into the document to be printed.

25. The printer of claim 24, further including a document creation engine configured to convert the rich media content into discrete frames to be incorporated in the document to be printed.

26. The printer of claim 24, wherein the document creation engine is further configured to insert one or more of the discrete frames into the document to be printed according to a selection criteria.

27. The printer of claim 26, wherein the selection criteria includes a digital signature algorithm.

28. The printer of claim 27, wherein converting the rich media content to one or more discrete frames to be incorporated in the document to be printed includes generating a digital signature for each of the one or more discrete frames.

29. The printer of claim 28, wherein selecting one or more discrete frames according to a selection criteria includes determining whether a discrete frame has a digital signature indicating a substantial deviation from associated discrete frames.

30. The printer of claim 29, wherein the document creation engine is further configured to identify erroneous or deviant content in the rich media content based on the substantial deviation from associated discrete frames.

31. The printer of claim 26, wherein inserting one or more of the discrete frames into the document to be printed according to a selection criteria includes selecting from among the discrete frames based on the total number of pages in the document to be printed.

32. The printer of claim 24, wherein inserting one or more of the discrete frames into the document to be printed according to a selection criteria includes receiving input from a user to select from among the discrete frames for insertion into the printed document.

33. The printer of claim 24, wherein the user interface is configured to receive input from a user to configure how at least one discrete frame is to be inserted into the printed document.

34. The printer of claim 33, wherein receiving input from a user includes receiving input from the user to position the selected discrete frame in the printed document.

35. The printer of claim 33, wherein receiving input from a user includes receiving input from the user to configure the appearance of the selected discrete frame in the printed document.

36. A system for creating a print document including rich media content, comprising:
means for receiving a document to be printed;
means for receiving rich media content to be associated with the document to be printed;
means for converting the rich media content to one or more discrete frames to be incorporated in the document to be printed; and
means for inserting the one or more discrete frames into the document to be printed.

37. The system of claim 36, wherein converting the rich media content to one or more discrete frames includes actuating an external application to generate the one or more discrete frames from the rich media content.

38. The system of claim 36, wherein inserting the one or more discrete frames into the document includes receiving a selection criteria to allow selection of one or more discrete frames.

39. The system of claim 38, wherein the selection criteria includes a digital signature level.

40. The system of claim 36, further including receiving input from a user to select from the one or more discrete frames for insertion in the printed document.

41. The system of claim 36, further including receiving input from a user to configure how a discrete frame is inserted into the printed document.

42. The system of claim 41, wherein receiving input from a user to configure how a discrete frame is inserted into the printed document includes receiving input from the user to position the discrete frame in the printed document.

43. The method of claim 9, wherein receiving input from a user to configure how a discrete frame is inserted into the printed document includes receiving input from the user to configure the appearance of the discrete frame in the printed document.
